(19) United States
(12) Patent Application Publication
(10) Pub. No.: US 2005/0227765 A1
(43) Pub. Date: Oct. 13, 2005

(54) Internet game method using four pillars for year, month, day, and hour of birth

(76) Inventor: In-Hwa Jung, Seo-gu, daejeon (KR)

Correspondence Address: CANTOR COLBURN, LLP, 55 GRIFFIN ROAD SOUTH, BLOOMFIELD, CT, 06002, US

(21) Appl. No.: 10/508,058

(22) PCT Filed: Mar. 18, 2003
(86) PCT No.: PCT/KR03/00522

§ 371 Date: Sep. 17, 2004

(30) Foreign Application Priority Data
Mar. 18, 2002 (KR) 10 2002 0014595

(51) Int. Cl. G06F 19/00; G06F 17/00

(52) U.S. Cl. 463/42

(57) ABSTRACT

Disclosed herein is an Internet game method using Four pillars for the year, month, day and hour of birth. In the Internet game method, a player (1) first inputs years, months, days and hours of birth of the player (1) and the partner of the player (1) at step S300. Fortunes according to the Four pillars for the year, month, day and hour of birth are generated by a Four-pillar program (33-1) and displayed on Four-pillar boxes (52 and 62) at step S400. A game is randomly selected from games generated by four reels (1R to 4R) by a game program (33-2) using one of the Eight Trigrams for divination selected by the player (1) and stages of the sexagenary cycle of the player (1) and the partner at step S500. Year of birth boxes (53-1 and 63-1), month of birth boxes (53-2 and 63-2), day of birth boxes (53-3 and 63-3) and hour of birth boxes (534 and 634) are extracted from reel game boxes (53 and 63) displaying the selected game, and are displayed separately at step S600. The extracted results are analyzed into fortunes of the player and the player's partner and a marital harmony therebetween as predicted by a fortuneteller on the basis of a game result analysis database (32-3).

### TECHNICAL FIELD

The present invention relates generally to an Internet game method using the “Four Pillars” for the year, month, day and hour of a birth, and more particularly to an Internet game method using the Four Pillars, in which, when information on the years, months, days and hours of births of a man and a woman is input, Four Pillars based on five elements (metal, wood, water, fire and earth) defined in the Book of Changes are generated by a Four Pillars program, pair slot games selected according to the generated Four Pillars are performed by a game program, and the fortunes of and the marital harmony between the man and the woman are predicted by interpreting results of the games based on symbolic images established relative to figures indicated on reels.

### BACKGROUND ART

In general, for methods of predicting the fortunes of and the marital harmony between a man and a woman, in the Orient the Book of Changes, Korean cards, Korean dominos, etc. are used, and in the West horoscopes based on astronomy are used or the fortune of and the marital harmony between a man and a woman are predicted by assigning symbolic images to trumps, tarot cards, Russian or gypsy cards, etc. and combining the symbolic images together.

In the Book of Changes mostly used in the Orient, the Four Pillars are interpreted based on the years, months, days and hours of births of a man and a woman, and the fortunes of and the romantic compatibility between the man and the woman are predicted by interpreting the Eight Trigrams for divination and the Sexagenary Cycle with respect to the Four Pillars.

The method of interpreting one's fortune or marital harmony by use of the Book of Changes has mostly been used off-line. However, a small number of programs for predicting one's fortune based on the year, month, day and hour of birth have been developed and used on the Internet.

However, those programs for predicting one's fortune or marital harmony between a man and a woman have not been precise or specialized, thereby failing to attract users' interest.

### DISCLOSURE OF THE INVENTION

Accordingly, the present invention has been made keeping in mind the above problem occurring in the prior art, and an object of the present invention is to provide an Internet game method using the Four Pillars, in which, when information on the years, months, days and hours of births of a man and a woman is input, Four Pillars based on five elements (metal, wood, water, fire and earth) defined in the Book of Changes are generated by a Four Pillars program, pair slot games selected according to the generated Four Pillars are performed by a game program, and the fortunes of and the marital harmony between the man and the woman are predicted by interpreting game results based on symbolic images established relative to figures indicated on reels.

In order to accomplish the above object, the present invention provides an Internet game method in which a player accesses a website of a server computer via an Internet and log in, including the birth information inputting step of the player having undergone the logging-in step entering years, months, days and hours of births of the player himself and a counterpart thereof in solar calendar boxes or lunar calendar boxes; the Four Pillars generating step of a Four Pillars program generating Four Pillars based on the Book of Changes depending upon the input years, months, days and hours of births of the player and the counterpart thereof and displaying the generated fortune on Four Pillar boxes; the game selecting step of a gram program randomly selecting a game among the games generated by four reels (1R through 4R) using the Eight Trigrams for divination selected through an Eight Trigrams selection box by the player and the Sexagenary Cycles of the player and the counterpart thereof; the game playing step of extracting year of birth boxes, month of birth boxes, day of birth boxes, and hour of birth boxes from reel game boxes that display the games selected using the Eight Trigrams and the Sexagenary Cycles, and displaying them in game boxes; and the game result interpreting step of a game result analyzing database analyzing and determining fortunes of and marital harmony between the player and the counterpart thereof through game results from the game boxes.

### BRIEF DESCRIPTION OF THE DRAWINGS

FIG. 1 is a system block diagram showing an Internet game method using the Four Pillars according to the present invention;

FIG. 2 is a flowchart showing the Internet game playing method using the Four Pillars according to the present invention;

FIG. 3 is a view illustrating a game box displayed on a website;

FIGS. 4 and 5 are views showing the generation of the Four Pillars;

FIGS. 6a and 6b are views showing the construction of a game based on the combinations of images arranged on four reels;

FIG. 7 is a view showing the classification of games according to the Eight Trigrams for divination;

FIGS. 8a to 8c are image combinations showing selected 60 games for women;

FIG. 9 is a score conversion table exemplifying the assignment of scores to the image combinations of each game box;

FIG. 10 is a score conversion table exemplifying the assignment of scores to the image combinations of two combined game boxes;

FIG. 11a is a table of game point grades with respect to each image;

FIG. 11b is a table of pair point grades with respect to each image;

FIG. 12 is a game screen of the website exemplifying an embodiment of the present invention;

FIG. 13 is a table of the Sexagenary Cycle based on the daily branches of the Four Pillars; and

FIG. 14 is an exemplary view showing images displayed on a plurality of reels.

### BEST MODE FOR CARRYING OUT THE INVENTION

Hereinafter, a preferred embodiment of the present invention is described in detail with reference to the accompanying drawings.

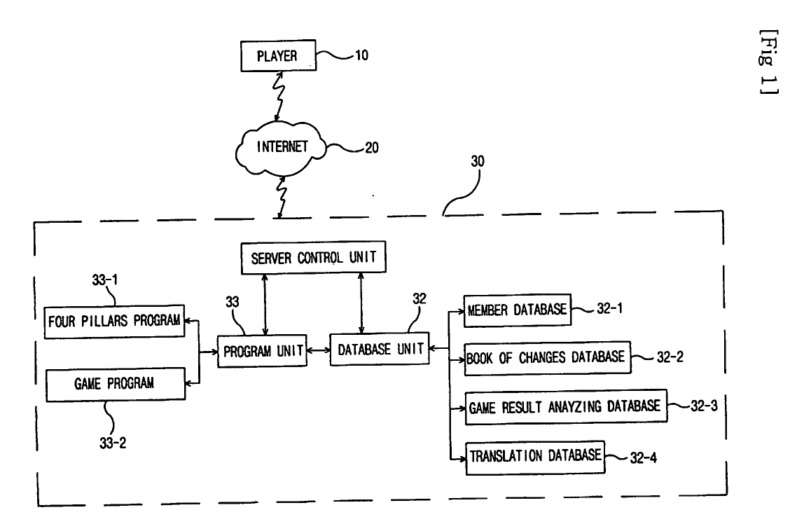

In accordance with the embodiment of the present invention, a plurality of players 10, as exemplified in FIG. 1, access a server computer 30 over the Internet through their respective Internet-accessible means, i.e., a computer, a Personal Digital Assistant (PDA) or a cellular phone, etc.

In this case, after the players 10 access the website of the server computer 30, they are provided with a variety of solutions from the website. The server computer 30 includes a server control unit 31, a database unit 32 and a program unit 33.

The database unit 32 includes a member database 32-1 for administrating member information, a Book of Changes database 32-2 for interpreting fortunes of each player 10 himself and a counterpart thereof, and a romantic compatibility between them (that is, martial harmony) by use of the Sexagenary Cycle, a game result analyzing database 33-3 for storing therein a table for game point grades and a table of pair point grades with respect to each image, and a translation database 32-4.

The program unit 33 includes a Four Pillars program 33-1 for generating fortunes of the player 10 and the counterpart thereof based on the years, months, days and hours of their births entered by the player 10 himself, as determined by the Four Pillars, and a game program 33-2 for displaying a game as selected according to the fortune determined by the Four Pillars of the player 10 and the counterpart thereof on a game box 54 for a woman and a game box 64 for a man so as to allow the player 10 to play the selected game.

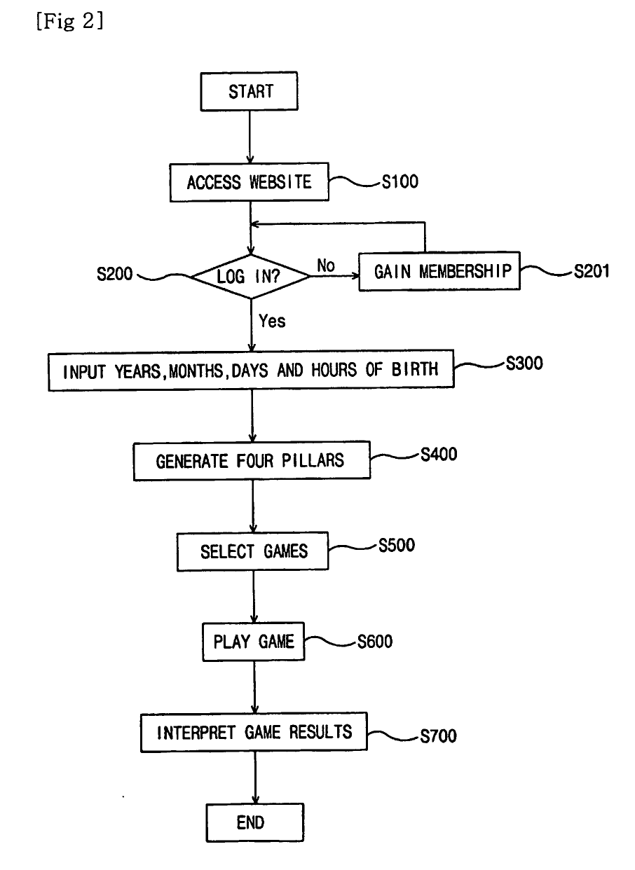

An Internet game method by use of one's fortune based on the Four Pillars generated according to the present invention comprising the above-described system will be described with reference to a flowchart as illustrated in FIG. 2.

At the step of accessing the website S100, the player 10 accesses the website of the server computer 30 over the Internet by means of an Internet accessing means (a computer, a PDA, a cellular phone, etc.).

If the player 10 selects “START” at the accessed website, he is requested to undergo the step of logging in S200 to authenticate his membership. At this logging-in step S200, if the player 10 is a member, he enters his ID and password and then his membership is authenticated. If the player 10 is not a member, he is requested to gain a membership and to be granted an ID and password at the step of registering membership S201, and then undergoes the logging-in step S200 again, thus authenticating his membership.

At this time, the server control unit 31 activates the member database 32-1 of the database unit 32 to ascertain whether the member information (ID, password or other personal information) inputted by the player 10 is identical to the information stored therein, or otherwise to store therein the member information (ID, password or other personal information) as inputted by the player 10.

The player 10 having undergone the logging-in step S200 is requested to enter, based either on a solar calendar or a lunar calendar, the years, months, days and hours of births of the player 10 and the counterpart thereof with respect to gender at the step of entering the year, month, day and hour of birth S300. When the player 10 enters the years, months, days and hours of births of the player 10 and the counterpart thereof based on a solar calendar or a lunar calendar, the server control unit 31 drives the Four Pillar program 33-1 of the program unit 33, converts their Four Pillars based on the solar calendar or the lunar calendar as entered by the player 10 into the Four Pillars based on the lunar calendar or the solar calendar, and displays them in solar calendar boxes 50 and 60 or lunar calendar boxes 51 and 61.

At the step of generating the Four Pillars based on the Book of Changes S400, the Four Pillars of the player 10 himself and the counterpart thereof based on the years, months, days and hours of their births inputted by the player 10 are generated in the Four Pillars program 33-1 of the Program unit 33, and are displayed in a female Four Pillar box 52 and a male Four Pillar box 62.

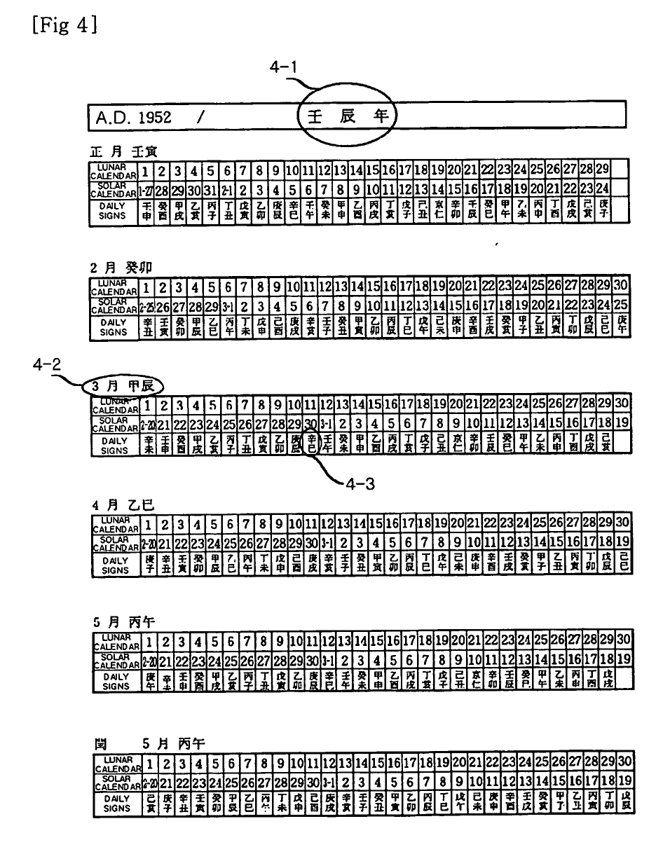

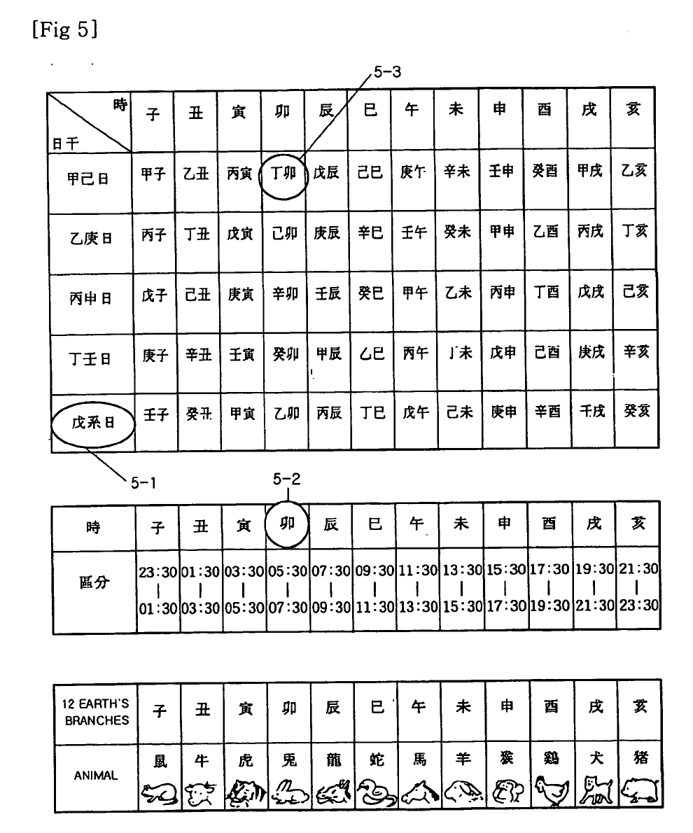

In other words, the Four Pillars program 33-1 of the program unit 33 generates the Ten Calendar Signs and the 12 Earth's Branches for the yearly Pillar 4-1, the monthly Pillar 4-2 and the hourly Pillar 4-3 based on the perpetual calendar as illustrated in FIG. 4 on the basis of the years, months, days and hours of births of the player 10 himself and the counterpart thereof entered by the player 10, at the same time, generates the hourly Pillar 5-3 based on the hour of his birth 5-2 according to the daily Branch 5-1 as illustrated in FIG. 5, and then displays them on the female Four Pillar box 52 and the male Four Pillar box 62.

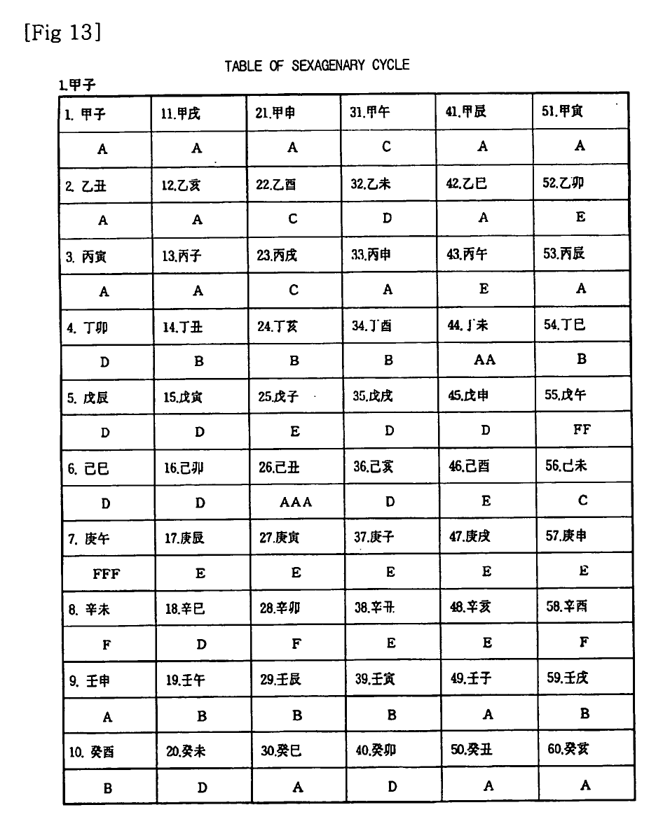

At this time, the Book of Changes database 32-2 of the database unit 32 as illustrated in FIG. 13 generates the Sexagenary Cycles according to the daily Signs based on the years, months, days and hours of the player 10 himself and the counterpart thereof entered by the player 10 either on the solar calendar boxes 50 and 60 or the lunar calendar boxes 51 and 61, on this basis, generates a romantic compatibility (marital harmony) between them through the daily Signs, and displays the result, irregardless of a game, thereby telling a romantic compatibility between the player and the counterpart thereof based on the Book of Changes.

When the Four Pillars of the player 10 and the counterpart are generated by the operation of the Four Pillar program 33-1 and displayed in the female Four Pillar box 52 and the male Four Pillar box 62, the player 10 may select games at the step of selecting games S500 using the Eight Trigrams for divination and the Sexagenary Cycles.

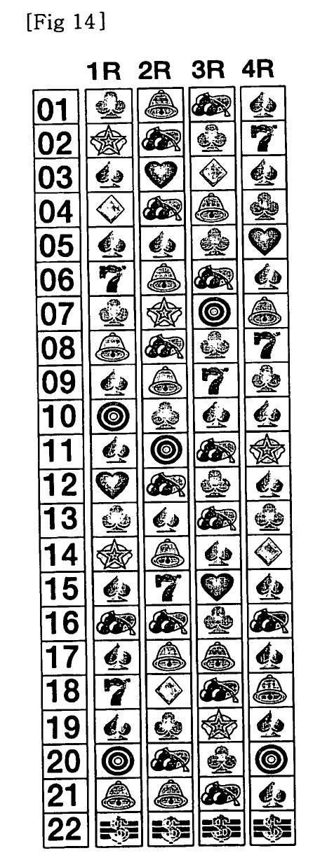

That is, at the step of selecting games S500 using the Eight Trigrams for divination and the Sexagenary Cycles, the game program 33-2 of the program unit 33 is operated according to control by the server controller 31, wherein games are generated by use of four reels (1R through 4R) as exemplified in FIG. 14, each reel comprising 22 boxes on which different images are arranged.

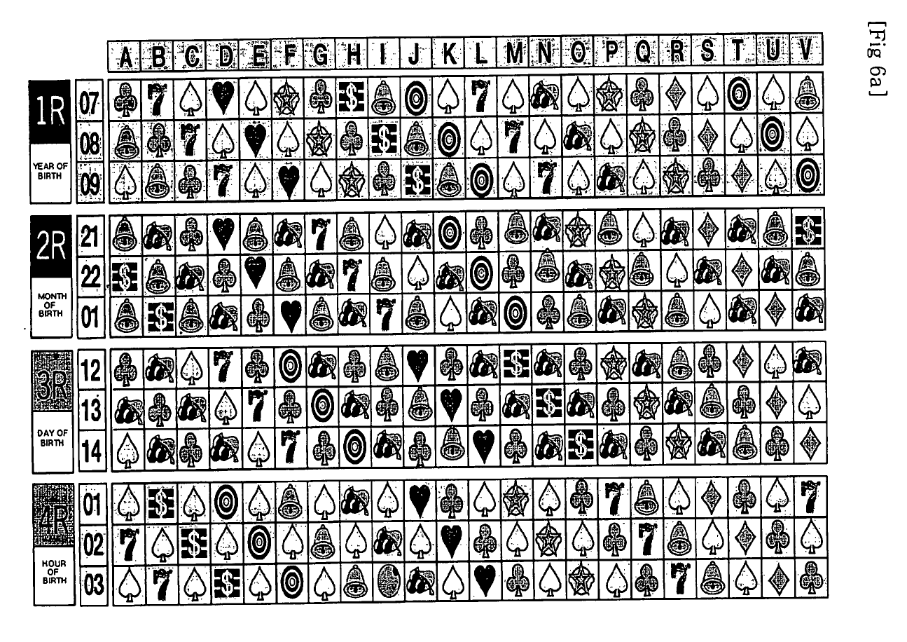

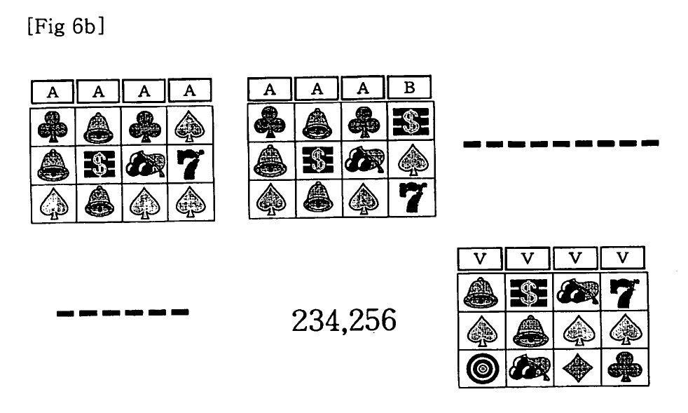

The game program 33-2 generates a great number of games through a total of 234,256 (22×22×22) image combinations as illustrated in FIGS. 6a and 6b by means of the rotating four reels, and the player 10 may select games among the 234,256 games based on the Eight Trigrams for divination and the Sexagenary Cycles.

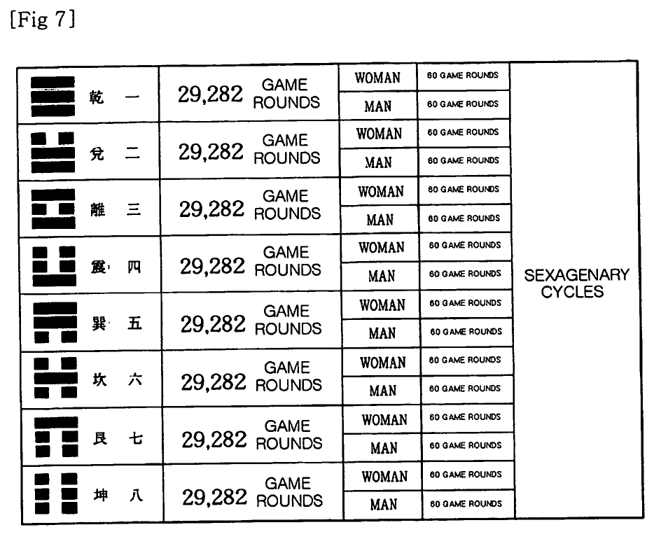

In other words, a box of selecting the Eight Trigrams for divination is displayed in the game program 33-2, wherein the player 10 is allowed to select one of the Eight Trigrams for divination comprising Gun (the first Trigram), Tae (the second Trigram), Li (the third Trigram), Jin (the fourth Trigram), Son (the fifth Trigram), Kam (the sixth Trigram), Kan (the seventh Trigram) and Kon (the eighth Trigram) as exemplified in FIG. 7.

At this time, if the player 10 presses a key on the keyboard as directed on the Eight Trigrams selecting box, a dodecahedral die is rotated. In the dodecahedral die, only 8 letters representing the Eight Trigrams for divination are indicated on the eight sides thereof.

Therefore, if a letter among the Eight Trigrams is selected from the dodecahedral die rotating on the Eight Trigrams selecting box, 29,282 games (234,256÷8) corresponding to one letter selected among the Eight Trigrams are selected as illustrated in FIG. 7. Where a side with no letter of the Eight Trigrams is selected by the rotating dodecahedral die, the player 10 is directed to repeat the step of selecting a letter until a side having a letter of the Eight Trigrams is selected.

In the game program 33-2, 60 games for women and 60 games for men, as illustrated in FIG. 7, are randomly selected among 488 games (29,282÷60), corresponding to the Sexagenary Cycles of the player 10 himself and the counterpart thereof, in 29,282 games corresponding to one of the Eight Trigrams selected by the player 10.

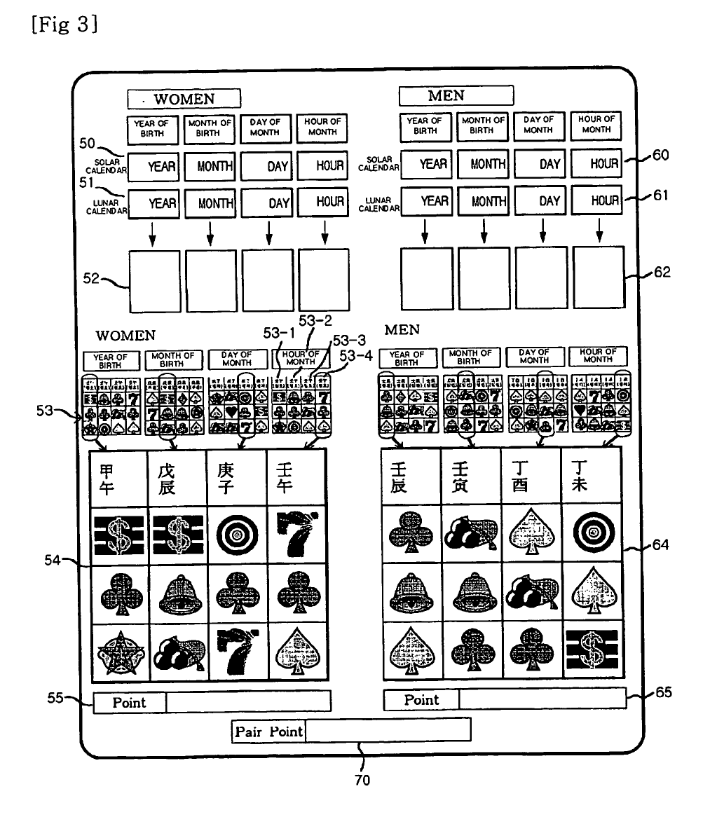

The game program 33-2 rotates the four reels (1R through 4R) to thereby drive a total of 120 games selected randomly, that is, 60 games for women and 60 games for men, and displays four reel game boxes for women 53 and four reel game boxes for men 63 on the screen as illustrated in FIG. 3.

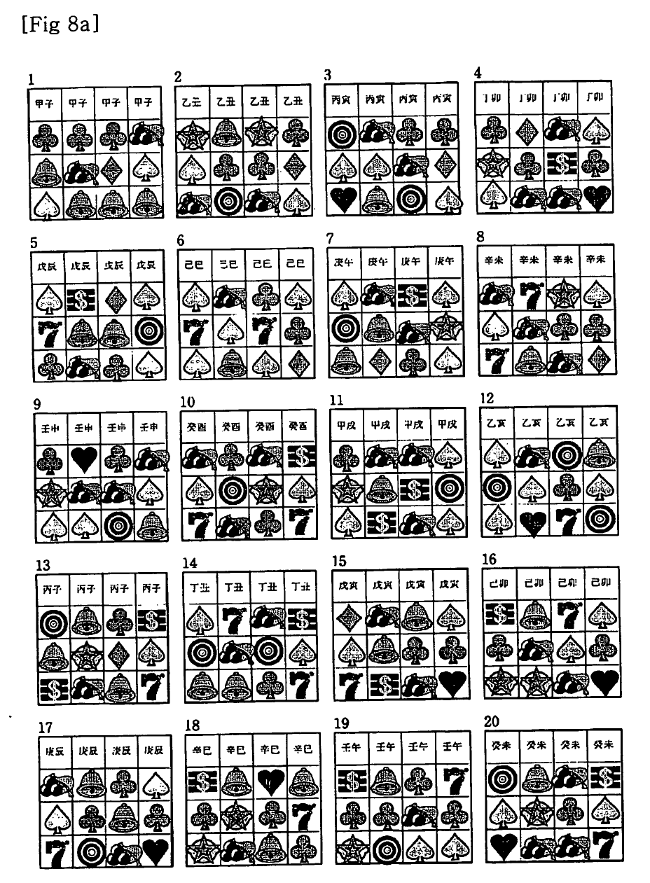

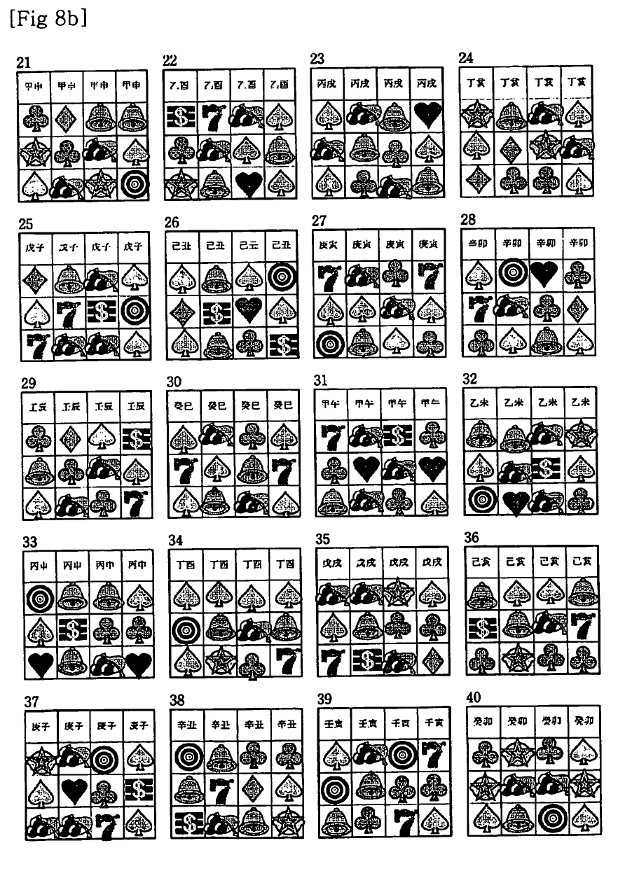

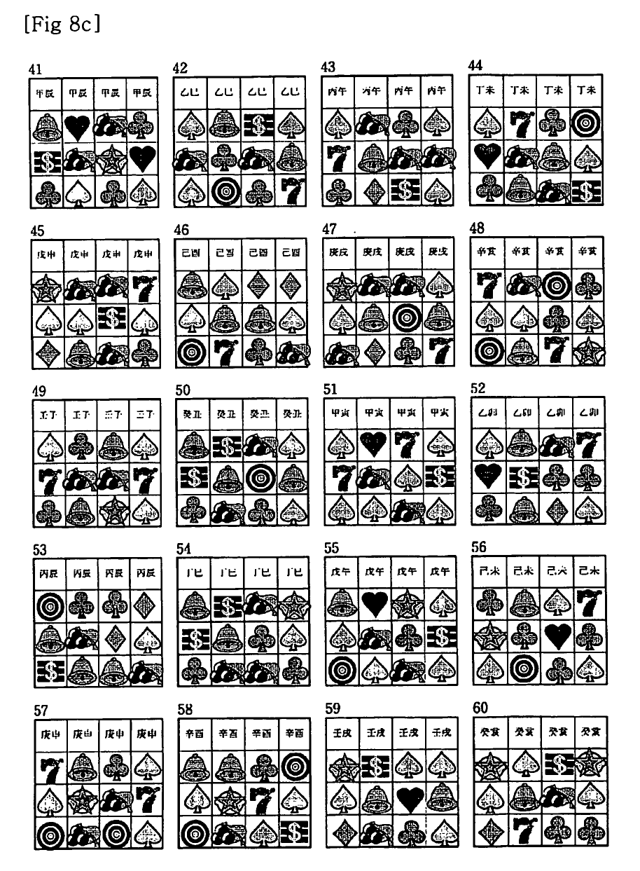

Herein, FIGS. 8a through 8c show image combinations for 60 games for women, wherein reel game boxes 53 and 63 each composed of four game rounds each comprise image combinations of three rows and four boxes, and the image combinations of four boxes are classified into year of birth boxes 53-1 and 63-1, month of birth boxes 53-2 and 63-2, day of birth boxes 53-3 and 63-3, and hour of birth boxes 53-4 and 63-4 from the left.

As illustrated in FIG. 3, the year of birth boxes 53-1 and 63-1 are extracted in the first game round from the left among four game rounds in the reel game boxes 53 and 63, the month of birth boxes 53-2 and 63-2 are extracted in the second game round, the day of birth boxes 53-3 and 63-3 are extracted in the third game round, and the hour of birth boxes 53-4 and 63-4 are extracted in the fourth game round, all of which are then displayed on the game box for woman 54 and the game box for man 64 in sequence.

At the step of playing games S600, games are performed through image arrangements generated in the female game box 54 and the male game box 64 separately or in combination as the game program 33-2 is driven.

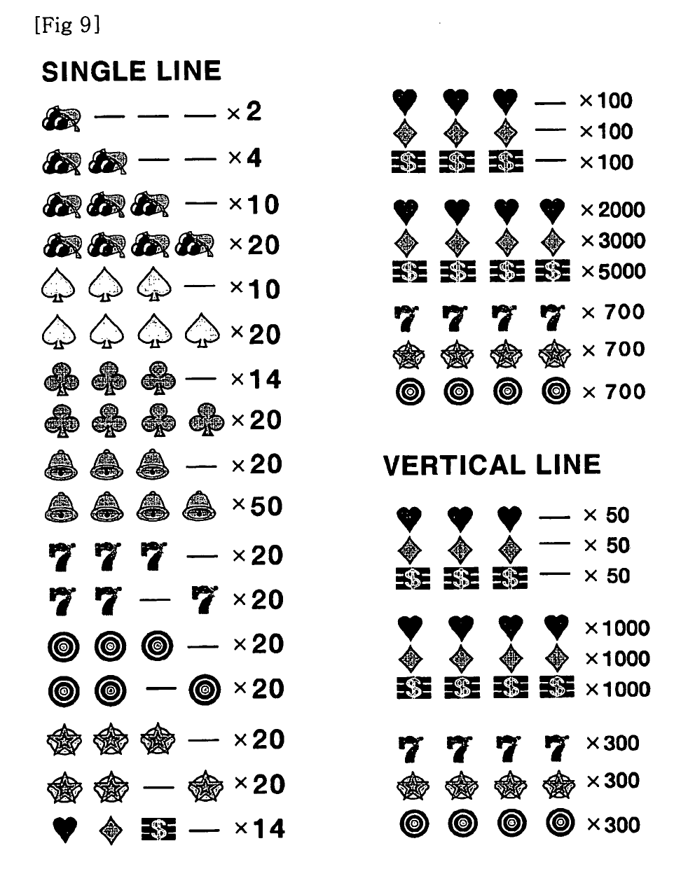

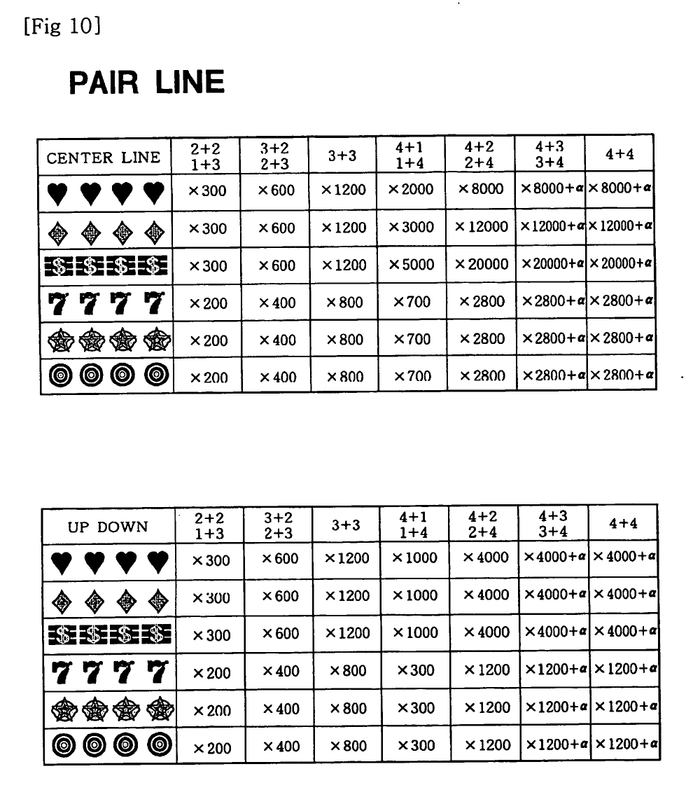

At this time, the game results in the female game box 54 and the male game box 64 are converted into scores, added up and then displayed on a woman game point box 55 and a man game point box 65 as illustrated in FIG. 9. The game results through image combinations subsequent to image arrangements separately generated in the female game box 54 and the male game box 64 are converted into scores, added up and then displayed on a pair game point box 70.

Meanwhile, at the step of reading the game results S700, the server control unit 31 drives a game result analyzing database 32-3 of the database unit 32 to thereby analyze and display game results generated in the game playing step S600.

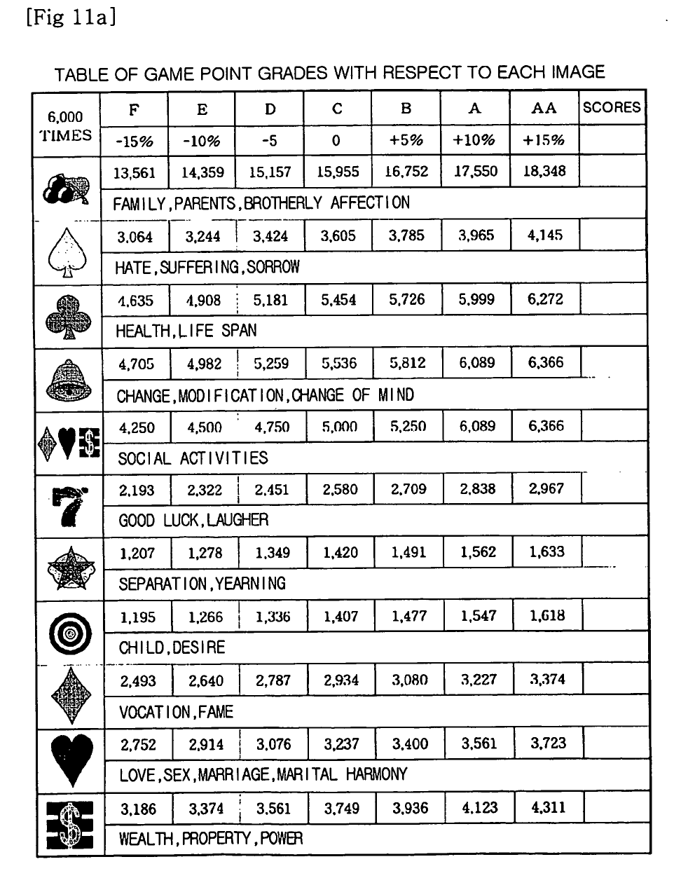

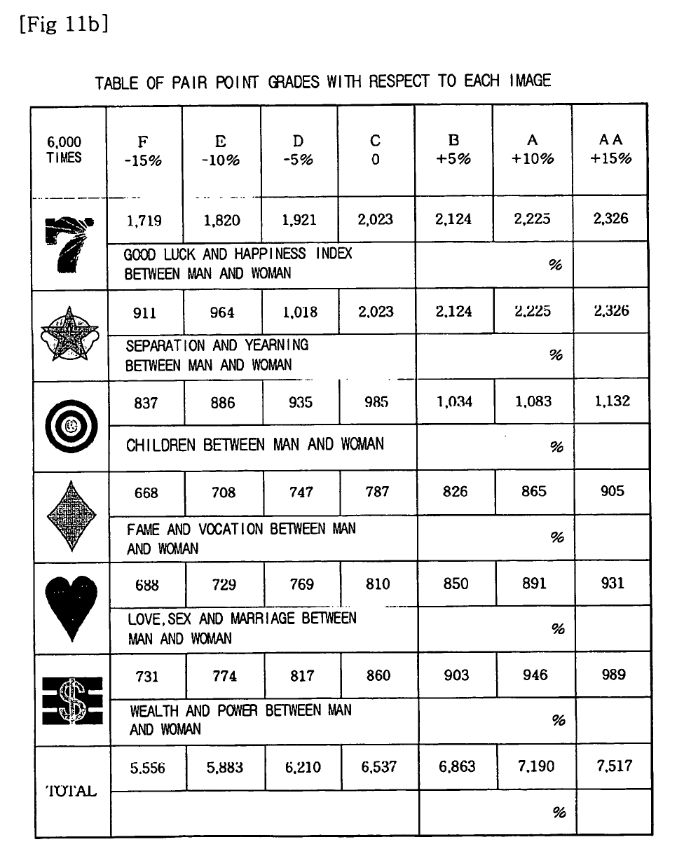

Into the game result analyzing database 32-3 are entered tables of grades in which game points with respect to each image are graded as illustrated in FIGS. 11a and 11b. On the basis of the tables of grades, the fortunes of and the marital harmony between them are analyzed.

In other words, the table of game point grades with respect to each image illustrated in FIG. 11a defines the frequency of each image (%) generated in the female game box 54 and the male game box 64 respectively through 1 billion game drives as a reference value (C grade). On the basis of the reference grade, 5% is added to or deducted from the reference value, and the results are then classified into B, A, AA grades or D, E, F grades in sequence and displayed. Referring to the table of grades, the game result analyzing database 32-3 determines the fortunes of the player 10 himself and the counterpart thereof, based on the frequency of each image (%) generated respectively in the female game box 54 and the male game box 64 as played according to selection by the player 10.

In the table of pair point grades with respect to each image as illustrated in FIG. 11b, the frequency of each image (%) generated through associated combinations of the female game box 54 and the male game box 64 through 1 billion game drives is defined as a reference value (C grade). On the basis of the reference grade, an increment or a decrement of 5% is added to or deducted from the reference value, and the result is then classified into B, A, AA grade or D, E, F grade in sequence which are displayed. Referring to the grade table, the game result analyzing database 32-3 determines the romantic compatibility (that is, marital harmony) between the player 10 and the counterpart thereof, based on the frequency of each image (%) generated through associated combinations of the female game box 54 and the male game box 64 as played according to selection by the player 10.

If the tables of grades as illustrated in FIGS. 11a and 11b are generated on the website, games according to the present invention have been finished.

Hereinafter, the present invention will be described in more detail according to one embodiment thereof.

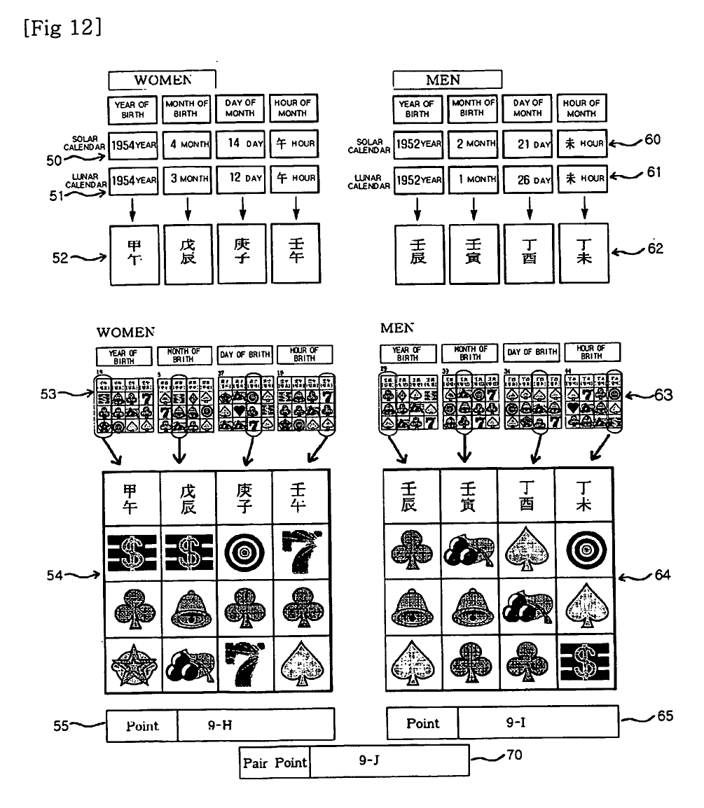

If the player 10 having undergone the logging-in step S200 after the website accessing step S100 inputs the years, months, days and hours of births of the player 10 and the counterpart thereof, based on the solar or lunar calendar, either in the solar calendar boxes 50 and 60 or the lunar calendar boxes 51 and 61 as illustrated in FIG. 12, the birth information thereof is automatically generated on the basis of lunar or solar calendars and then entered into the lunar calendar boxes 51 and 61 or the solar calendar boxes 50 and 60.

Based on the years, months, days and hours of births of the player 10 and the counterpart inputted in the solar calendar boxes 50 and 60 or the lunar calendar boxes 51 and 61, the Four Pillars and the Eight Characters thereof are generated and inputted in the female Four Pillar box 52 and the male Four Pillar box 62.

If games are selected based on one of the Eight Trigrams selected and the Sexagenary Cycles selected according to the Four Pillars and the Eight Characters inputted in the female Four Pillar box 52 and the male Four Pillar box 62, the game starts through the reel game boxes 53 and 63. Subsequently, the years of birth boxes 53-1 and 63-1, the months of birth boxes 53-2 and 63-2, the days of birth boxes 53-3 and 63-3 and the hours of birth boxes 53-4 and 63-4 are extracted from the reel game boxes 53 and 63, and are in turn displayed in the female game box 54 and the male game box 64.

At this time, image combinations in the female game box 54 and the male game box 64 are converted into scores in the woman game point box 55, the man game point box 65 and the pair game point box 70, and the converted scores are added up.

If the game is finished, a table of game point grades with respect to each image and a table of pair point grades with respect to each image are generated based on the game results. On this basis, the fortunes of and the romantic compatibility (marital harmony) between the player 10 himself and the counterpart thereof are determined.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not limited to the above-described embodiment, but is to be determined by the following claims and the equivalents thereof.

### INDUSTRIAL APPLICABILITY

The method of the present invention is capable of not only predicting the fortunes of and the romantic compatibility (marital harmony) between the player and the counterpart thereof based on the Book of Changes over the Internet using the years, months, days and hours of births of the player and his counterpart, but also analyzing their fortunes and marital harmony based on game results after enjoying the game, thus being utilized as a useful Internet game method that can continuously attract users' interest and attention.

1. An Internet game method in which a player (10) accesses a website of a server computer (30) via an Internet (20) at step (S100) and undergoes logging-in step (S200), comprising:
the birth information inputting step (S300) of the player (10) having undergone the logging-in step (S200) entering years, months, days and hours of births of the player (10) himself and a counterpart thereof in solar calendar boxes (50 and 60) or lunar calendar boxes (51 and 61);
the Four Pillars generating step (S400) of a Four Pillars program (33-1) generating Four Pillars based on the Book of Changes depending upon the input years, months, days and hours of births of the player (10) and the counterpart thereof and displaying the generated fortune on Four Pillar boxes (52 and 62);
the game selecting step (S500) of a gram program (33-2) randomly selecting a game among the games generated by four reels (1R through 4R) using the Eight Trigrams for divination selected through an Eight Trigrams selection box by the player (1) and the Sexagenary Cycles of the player and the counterpart thereof;
the game playing step (S600) of extracting year of birth boxes (53-1 and 63-1), month of birth boxes (53-2 and 63-2), day of birth boxes (53-3 and 63-3), and hour of birth boxes (53-4 and 63-4) from reel game boxes (53 and 63) that display the games selected using the Eight Trigrams and the Sexagenary Cycles, and displaying them in game boxes (54 and 64); and
the game result interpreting step (S700) of a game result analyzing database (32-3) analyzing and determining fortunes of and marital harmony between the player (10) and the counterpart thereof through game results from the game boxes (54 and 64).

2. The method according to claim 1, wherein the game selecting step (S500) is performed in such a way that games corresponding to one letter indicating one of the Eight Trigrams are selected through a dodecahedral die displayed on the Eight Trigrams box, games corresponding to the Sexagenary Cycles of the player (10) and the counterpart thereof are selected among the firstly selected games, and then games for men and women are randomly selected among the secondly selected games.

3. The method according to claim 1, wherein the game playing step (S600) is performed in such a way that image arrangements generated in the two game boxes (54 and 64) are converted into scores separately or in combination and added up, and then displayed in the male and female game point boxes (55 and 65) and the pair game point box (70).

4. The method according to claim 1, wherein the game result interpreting step (S700) is performed in such a way that image data displayed as the game results from the game boxes (54 and 64) are interpreted into the fortunes of and the marital harmony between the player (10) and the counterpart thereof on the basis of predetermined symbolic images with respect to each image.
